(19) United States
(12) Patent Application Publication
(10) Pub. No.: US 2022/0400058 A1
(43) Pub. Date: Dec. 15, 2022

(54) COMMISSIONING OF OPTICAL SYSTEM WITH MULTIPLE MICROPROCESSORS

(71) Applicant: Infinera Corp., San Jose, CA (US)

(72) Inventors: Madhumita Pal, San Jose, CA (US); Dale Chin, San Jose, CA (US); Ramanujan Puranam, San Jose, CA (US); Madhura Joshi, Fremont, CA (US)

(21) Appl. No.: 17/841,092

(22) Filed: Jun. 15, 2022

Related U.S. Application Data
(60) Provisional application No. 63/210,538, filed on Jun. 15, 2021.

(51) Int. Cl. H04L 41/0895; H04L 41/0803

(52) U.S. Cl. CPC H04L 41/0895; H04L 41/0803; G06F 9/547

(57) ABSTRACT

A network element is herein disclosed. The network element comprises a controller card and a pluggable card. The controller card comprises a first processor; a first memory, the first memory being a first non-transitory computer-readable medium storing computer-executable instructions comprising a common software stack and a first microservice stack; and a first device; wherein the first microservice stack includes a first microservice operable to manage the first device. The pluggable card comprises a second processor; a second memory, the second memory being a second non-transitory computer-readable medium storing computer-executable instructions comprising the common software stack and a second microservice stack; and a second device; wherein the second microservice stack includes a second microservice operable to manage the second device.

### CROSS REFERENCE TO RELATED APPLICATION

This application claims the benefit of U.S. Provisional Patent Application No. 63/210,538, filed on Jun. 15, 2021, the entire content of which is hereby incorporated herein by reference in its entirety.

### BACKGROUND

Optical communication systems typically include a first node that supplies optical signals carrying user information or data to a second node that receives such optical signals via an optical communication path that connects the first node to the second node. In certain optical communication systems, the first node is a so-called hub node that communicates with a plurality of second nodes, also referred to as leaf nodes. The optical communication paths that connect the hub with multiple leaf nodes may include one or more segments of optical fiber connected to one another by various optical components or sub-systems, such as optical amplifiers, optical splitters and combiners, optical multiplexers and demultiplexers, and optical switches, for example, wavelength selective switches (WSS). The optical communication path and its associated components may be referred to as a line system.

In each node, the various optical components or sub-systems and the various electrical components and subsystems may each include at least one microprocessor and each node may include at least one processor communicating with each microprocessor. Software development and board bring-up time is proportional to the number of microprocessors in an embedded system. Communication between the microprocessors and the software stack is fundamental for a quick bring-up and successful runtime of the node.

Traditional solutions to reducing development time and simplifying development on a multiprocessor embedded system includes identifying common reusable code blocks across the processor or treating each processor subsystem as an independent software block which is written to extract maximum efficiency from underlying microprocessor hardware without seeking commonality. However, traditional solutions result in difficulties in maintaining versioning and compatibility of reusable components as the number of subsystems increases and if each subsystem is treated as an independent software block, code duplication increases, which in turn increases the chance of bugs and other defects.

Therefore, a need exists for a system having a standardized interface and a common software stack executed on each processor while core subsystem functionality is maintained in a microservice software stack.

### SUMMARY

The problem of having a standardized interface and a common software stack executed on each processor while core subsystem functionality is maintained in a microservice software stack is solved by a network element comprising a controller card and a pluggable card. The controller card comprises a first processor; a first memory, the first memory being a first non-transitory computer-readable medium storing computer-executable instructions comprising a common software stack and a first microservice stack; and a first device; wherein the first microservice stack includes a first microservice operable to manage the first device. The pluggable card comprises a second processor; a second memory, the second memory being a second non-transitory computer-readable medium storing computer-executable instructions comprising the common software stack and a second microservice stack; and a second device; wherein the second microservice stack includes a second microservice operable to manage the second device.

Implementations of the above techniques include methods, apparatus, systems, and computer program products. One such computer program product is suitably embodied in a non-transitory computer-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagrammatic view of an exemplary embodiment of hardware forming a system for uniform management of distributed microservices constructed in accordance with the present disclosure.

FIG. 2 is a diagrammatic view of an exemplary embodiment of a user device for use in the system of FIG. 1.

FIG. 3 is a diagrammatic view of an exemplary embodiment of a cloud-based server for use in the system of FIG. 1.

FIG. 4 is a diagrammatic view of an exemplary embodiment of a network element for use in the system of FIG. 1.

FIG. 5 is a diagrammatic view of an exemplary embodiment of an embedded device of FIG. 4.

FIG. 6 is a diagrammatic view of an exemplary embodiment of a control card of FIG. 4.

FIG. 7 is a functional diagram of the network element of FIG. 4 constructed in accordance with the present disclosure.

### DETAILED DESCRIPTION

The following detailed description of example embodiments refers to the accompanying drawings. The same reference numbers in different drawings may identify the same or similar elements.

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value. It is not intended that the scope of the invention be limited to the specific values recited when defining a range. All ranges are inclusive and combinable.

When values are expressed as approximations, e.g., by use of the antecedent “about,” it will be understood that the particular value forms another embodiment. Reference to a particular numerical value includes at least that particular value, unless the context clearly dictates otherwise. The term “about” when used in reference to numerical ranges, cutoffs, or specific values is used to indicate that the recited values may vary by up to as much as 10% from the listed value. Thus, the term “about” is used to encompass variations of ±10% or less, variations of ±5% or less, variations of ±1% or less, variations of ±0.5% or less, or variations of ±0.1% or less from the specified value.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), a field programmable gate array (FPGA), a combination of hardware and software, and/or the like. The term “processor” as used herein means a single processor or multiple processors working independently or together to collectively perform a task.

Software may include one or more computer readable instruction that when executed by one or more component, e.g., a processor, causes the component to perform a specified function. It should be understood that the algorithms described herein may be stored on one or more non-transitory computer-readable medium. Exemplary non-transitory computer-readable mediums may include random access memory (RAM), a read only memory (ROM), a CD-ROM, a hard drive, a solid-state drive, a flash drive, a memory card, a DVD-ROM, a BluRay Disk, a disk, an optical drive, combinations thereof, and/or the like.

Such non-transitory computer-readable mediums may be electrically based, optically based, magnetically based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

As used herein, a “route” and/or an “optical route” may correspond to an optical path and/or an optical light-path. For example, an optical route may specify a path along which light is carried between two or more network entities.

Users of optical networks may want to determine information associated with the optical network. Optical network information may be difficult to obtain, aggregate, and display. Implementations described herein assist a user in obtaining and viewing aggregated optical network information, such as network information associated with network entities and optical links between the network entities.

As used herein, an optical link may be an optical fiber, an optical channel, an optical super-channel, a super-channel group, an optical carrier group, a set of spectral slices, an optical control channel (e.g., sometimes referred to herein as an optical supervisory channel, or an “OSC”), an optical data channel (e.g., sometimes referred to herein as “BAND”), and/or any other optical signal transmission link.

In some implementations, an optical link may be an optical super-channel. A super-channel may include multiple channels multiplexed together using wavelength-division multiplexing in order to increase transmission capacity. Various quantities of channels may be combined into super-channels using various modulation formats to create different super-channel types having different characteristics. Additionally, or alternatively, an optical link may be a super-channel group. A super-channel group may include multiple super-channels multiplexed together using wavelength-division multiplexing in order to increase transmission capacity.

Additionally, or alternatively, an optical link may be a set of spectral slices. A spectral slice (a “slice”) may represent a spectrum of a particular size in a frequency band (e.g., 12.5 gigahertz (“GHz”), 6.25 GHz, etc.). For example, a 4.8 terahertz (“THz”) frequency band may include 384 spectral slices, where each spectral slice may represent 12.5 GHz of the 4.8 THz spectrum. A super-channel may include a different quantity of spectral slices depending on the super-channel type.

The generation of laser beams for use as optical data carrier signals is explained, for example, in U.S. Pat. No. 8,155,531, entitled “Tunable Photonic Integrated Circuits”, issued Apr. 10, 2012, and U.S. Pat. No. 8,639,118, entitled “Wavelength division multiplexed optical communication system having variable channel spacings and different modulation formats,” issued Jan. 28, 2014, which are hereby fully incorporated in their entirety herein by reference.

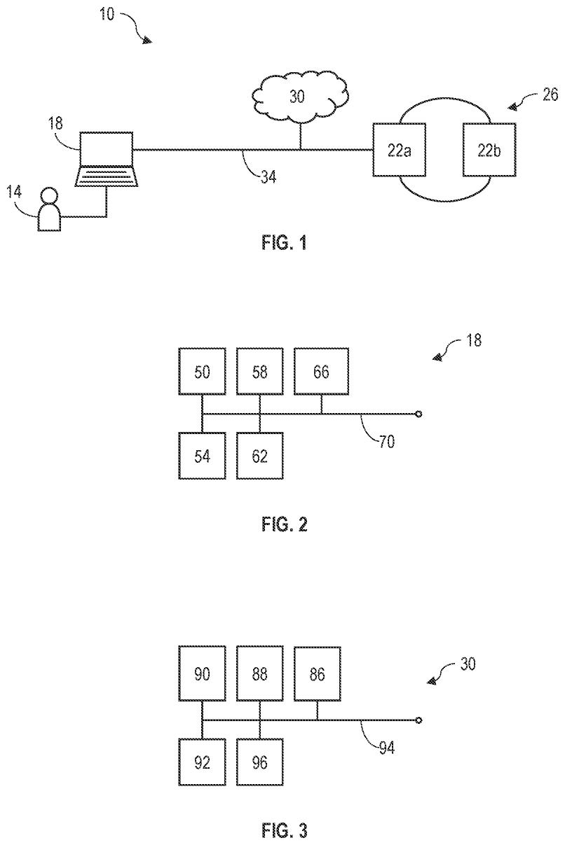

Referring now to the drawings, and in particular to FIG. 1, shown therein is a diagram of an exemplary embodiment of a system 10 for commissioning of optical systems with multiple microprocessors constructed in accordance with the present disclosure. A user 14 may interact with the system 10 using a user device 18 that may be used to communicate with one or more network element 22, such as a first node 22a and/or a second node 22b of an optical network 26. The user device 18 may communicate with the optical network 26 and/or a cloud-based server 30 via a network 34.

In some embodiments, the cloud-based server 30 may comprise a processor and a memory having a data lake that may store copies of data such as sensor data, system data, metrics, logs, tracing, and/or the like. The data lake may include structured data from relational databases, semi-structured data, unstructured data, time-series data, and binary data. The data lake may be a data base, a remote accessible storage, or a distributed file system. The cloud-based server 30 is discussed in more detail below, in relation to FIG. 3.

In some embodiments, the network 34 may be the Internet and/or other network. For example, if the network 34 is the Internet, a primary user interface of the system 10 may be delivered through a series of web pages or private internal web pages of a company or corporation, which may be written in hypertext markup language, and accessible by the user device 18. It should be noted that the primary user interface of the system 10 may be another type of interface including, but not limited to, a Windows-based application, a tablet-based application, a mobile web interface, an application running on a mobile device, and/or the like.

The network 34 may be almost any type of network. For example, in some embodiments, the network 34 may be a version of an Internet network (e.g., exist in a TCP/IP-based network). In one embodiment, the network 34 is the Internet. It should be noted, however, that the network 34 may be almost any type of network and may be implemented as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like. It is conceivable that in the near future, embodiments of the present disclosure may use more advanced networking topologies.

Optical network 26 may include any type of network that uses light as a transmission medium. For example, optical network 26 may include a fiber-optic based network, an optical transport network, a light-emitting diode network, a laser diode network, an infrared network, combinations thereof, and/or other types of optical networks.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of system 10 may perform one or more functions described as being performed by another one or more of the devices of the system 10. Devices of the system 10 may interconnect via wired connections, wireless connections, or a combination thereof.

Referring now to FIG. 2, shown therein is a diagram of an exemplary embodiment of the user device 18 of the system 10 constructed in accordance with the present disclosure. In some embodiments, the user device 18 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some embodiments, the user device 18 may include one or more input device 50 (hereinafter “input device 50”), one or more output device 54 (hereinafter “output device 54”), one or more processor 58 (hereinafter “processor 58”), one or more communication device 62 (hereinafter “communication device 62”) capable of interfacing with the network 34, one or more non-transitory computer-readable memory 66 (hereinafter “memory 66”) storing processor-executable code and/or software application(s), for example including, a web browser capable of accessing a website and/or communicating information and/or data over a wireless or wired network (e.g., the network 34), and/or the like. The input device 50, output device 54, processor 58, communication device 62, and memory 66 may be connected via a path 70 such as a data bus that permits communication among the components of user device 18.

The memory 66 may store an application 74 that, when executed by the processor 58 causes the user device 18 to perform an action such as communicate with or control one or more component of the user device 18 and/or the network 34.

The input device 50 may be capable of receiving information input from the user 14 and/or processor 58, and transmitting such information to other components of the user device 18 and/or the network 34. The input device 50 may include, but is not limited to, implementation as a keyboard, a touchscreen, a mouse, a trackball, a microphone, a camera, a fingerprint reader, an infrared port, a slide-out keyboard, a flip-out keyboard, a cell phone, a PDA, a remote control, a fax machine, a wearable communication device, a network interface, combinations thereof, and/or the like, for example.

The output device 54 may be capable of outputting information in a form perceivable by the user 14 and/or processor 58. For example, implementations of the output device 54 may include, but are not limited to, a computer monitor, a screen, a touchscreen, a speaker, a website, a television set, a smart phone, a PDA, a cell phone, a fax machine, a printer, a laptop computer, a haptic feedback generator, combinations thereof, and the like, for example. It is to be understood that in some exemplary embodiments, the input device 50 and the output device 54 may be implemented as a single device, such as, for example, a touchscreen of a computer, a tablet, or a smartphone. It is to be further understood that as used herein the term user (e.g., the user 14) is not limited to a human being, and may comprise a computer, a server, a website, a processor, a network interface, a user terminal, a virtual computer, combinations thereof, and/or the like, for example.

The network 34 may permit bi-directional communication of information and/or data between the user device 18, the cloud-based server 30, and/or the network element 22. The network 34 may interface with the cloud-based server 30, the user device 18, and/or the network element 22 in a variety of ways. For example, in some embodiments, the network 34 may interface by optical and/or electronic interfaces, and/or may use a plurality of network topographies and/or protocols including, but not limited to, Ethernet, TCP/IP, circuit switched path, combinations thereof, and/or the like. The network 34 may utilize a variety of network protocols to permit bi-directional interface and/or communication of data and/or information between the cloud-based server 30, the user device 18 and/or the network element 22.

Referring now to FIG. 3, shown therein is a diagram of an exemplary embodiment of cloud-based server 30 constructed in accordance with the present disclosure. In the illustrated embodiment, the cloud-based server 30 is provided with one or more processor 88 (hereinafter “processor 88”) and a non-transitory computer-readable storage memory 86 (hereinafter “memory 86”) accessible by the processor 88 of the cloud-based server 30.

In some embodiments, the cloud-based server 30 may comprise one or more processor 88 working together, or independently to, execute processor-executable code stored on the memory 86. Additionally, each cloud-based server 30 may include at least one input device 90 (hereinafter “input device 90”) and at least one output device 92 (hereinafter “output device 92”). Each element of the cloud-based server 30 may be partially or completely network-based or cloud-based, and may or may not be located in a single physical location. It is to be understood, that in certain embodiments using more than one processor 88, the processors 88 may be located remotely from one another, located in the same location, or comprising a unitary multi-core processor. The processors 88 may be capable of reading and/or executing processor-executable code and/or capable of creating, manipulating, retrieving, altering, and/or storing data structures into the memory 86.

Exemplary embodiments of the processor 88 may include, but are not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The processor 88 may be capable of communicating with the memory 86 via a path 94 (e.g., data bus). The processor 88 may be capable of communicating with the input device 90 and/or the output device 92.

The processor 88 may be further capable of interfacing and/or communicating with the user device 18 and/or the network elements 22 via the network 34 using a communication device 96. For example, the processor 88 may be capable of communicating via the network 34 by exchanging signals (e.g., analog, digital, optical, and/or the like) via one or more ports (e.g., physical or virtual ports) using a network protocol to provide information to the user device 18.

The memory 86 may be implemented as a conventional non-transitory memory, such as for example, random access memory (RAM), CD-ROM, a hard drive, a solid-state drive, a flash drive, a memory card, a DVD-ROM, a disk, an optical drive, combinations thereof, and/or the like, for example.

In some embodiments, the memory 86 may be located in the same physical location as the cloud-based server 30, and/or one or more memory 86 may be located remotely from the cloud-based server 30. For example, the memory 86 may be located remotely from the cloud-based server 30 and communicate with the processor 88 via the network 34. Additionally, when more than one memory 86 is used, a first memory 86 may be located in the same physical location as the processor 88, and additional memory 86 may be located in a location physically remote from the processor 88. Additionally, the memory 86 may be implemented as a “cloud” non-transitory computer-readable storage memory (i.e., one or more memory 86 may be partially or completely based on or accessed using the network 34).

The input device 90 of the cloud-based server 30 may transmit data to the processor 88 and may be similar to the input device 50 of the user device 18. The input device 90 may be located in the same physical location as the processor 88, or located remotely and/or partially or completely network-based. The output device 92 of the cloud-based server 30 may transmit information from the processor 88 to the user 12 or a network element 22, and may be similar to the output device 54 of the user device 18. The output device 92 may be located with the processor 88, or located remotely and/or partially or completely network-based.

The memory 86 may store processor-executable code and/or information comprising a database and a cloud server software.

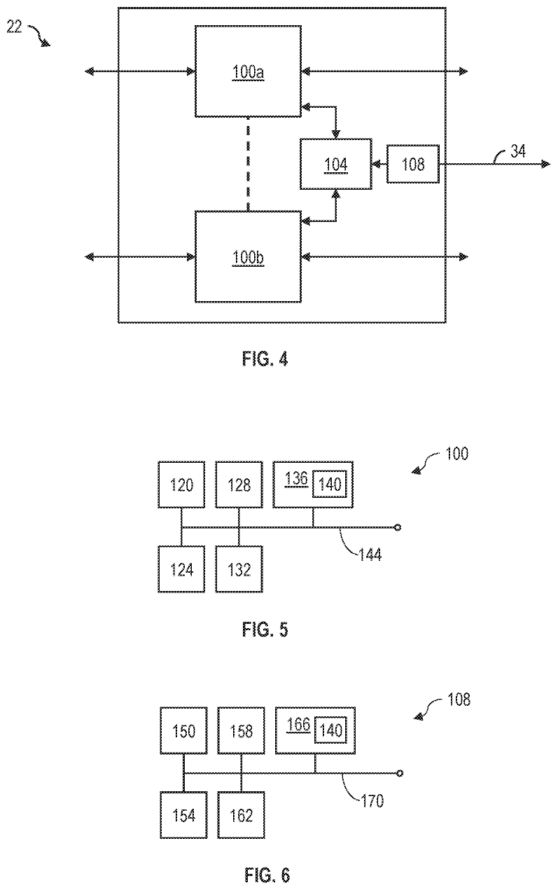

Referring now to FIG. 4, shown therein is a diagram of an exemplary embodiment of a node 22, such as the first node 22a and/or the second node 22b of FIG. 1, constructed in accordance with the present disclosure. The node 22 generally comprises an embedded device 100 (shown as embedded device 100a and embedded device 100b), a communication device 104 to allow one or more component of the node 22 to communicate to one or more other component of the node 22 or to another node 22 in the system 10 via the network 34, and a controller card 108.

Network element 22 may include one or more device that gathers, processes, stores, and/or provides information in response to a request in a manner described herein. For example, Network element 22 may include one or more optical data processing and/or traffic transfer device, such as an optical node, an optical amplifier (e.g., a doped fiber amplifier, an erbium doped fiber amplifier, a Raman amplifier, etc.), an optical add-drop multiplexer (“OADM”), a reconfigurable optical add-drop multiplexer (“ROADM”), a flexibly reconfigurable optical add-drop multiplexer module (“FRM”), an optical source component (e.g., a laser source, or optical laser), an optical source destination (e.g., a laser sink), an optical multiplexer, an optical demultiplexer, an optical transmitter, an optical receiver, an optical transceiver, a photonic integrated circuit, an integrated optical circuit, a computer, a server, a router, a bridge, a gateway, a modem, a firewall, a switch, a network interface card, a hub, and/or any type of device capable of processing and/or transferring optical traffic.

In some implementations, the network element 22 may include a OADM and/or a ROADM capable of being configured to add, drop, multiplex, and demultiplex optical signals. Network element 22 may process and transmit optical signals to another network element 22 throughout the optical network 26 in order to deliver optical transmissions.

Layer 1 specific embodiments of the network element 22 may optionally be provided with additional elements that are not shown in the Figures such as an optical transceiver, a digital signal processor (DSP), and additional high-speed integrated circuit (ASIC or FPGA) that is specialized to handle high-speed data frames/packets.

Layer 0 specific embodiments of network element 22 may optionally be provided with additional elements that are not shown in the Figures such as a Wavelength Selective Switch (WSS), Variable Optical Attenuator (VOA), Erbium Doped Fiber Amplifier (EDFA), or Raman amplifiers, and optical channel monitors, for instance.

In one embodiment, the embedded device 100 includes one or more digital coherent optics module having one or more coherent optical transceiver operable to receive a client data from an electrical signal and transmit the client data in an optical signal and/or receive the client data from an optical signal and transmit the client data in an electrical signal, or a combination thereof. In one embodiment, the embedded device 100 may include one or more of the Layer 1 elements and/or Layer 0 elements as detailed above. The embedded optical device may have one or more property affecting a function of the embedded device and one or more status indicative of a current state of at least one component of the embedded device.

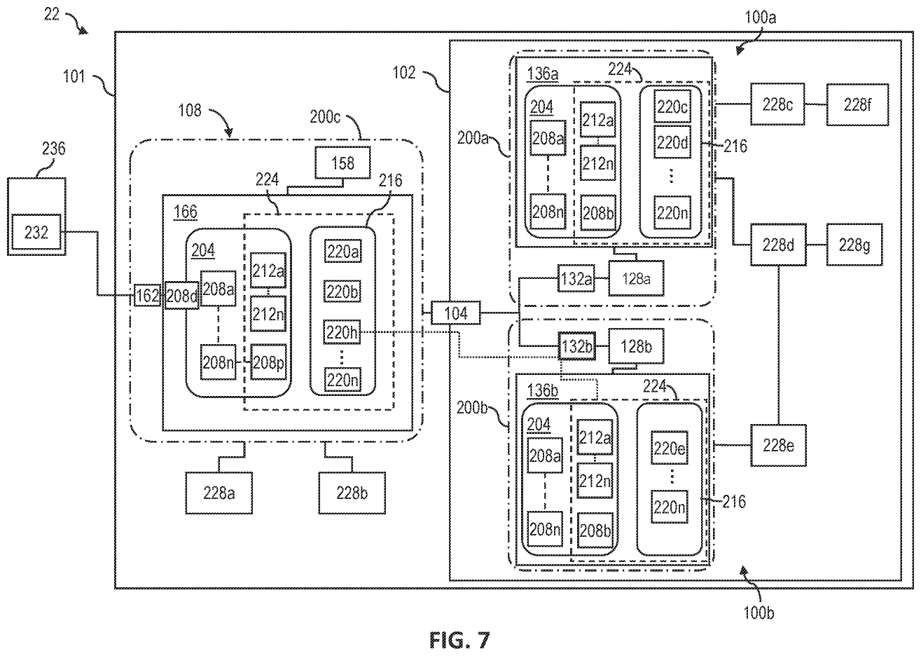

In accordance with the present disclosure, the network element 22 may be a holder, like a chassis, or a contained/logical equipment, like an optical line card within the chassis. In one embodiment, the network element 22 may be a logical entity comprising one or more chassis 101 having one or more pluggable cards 102 that form the network element 22, as shown in FIG. 7 and described in more detail below. For instance, pluggable cards may include traffic carrying (“data plane”) cards that may have customized silicon such as ASICs or FPGAs that process the data frames/packets, based on the functionality of the card. Another exemplary traffic carrying card is a router line-card which has packet processing ASICs or other specialized silicon. Another exemplary optical line card includes a DSP module and/or optical photonic circuits. Control cards 108 (“control and management plane”) do not process data packets but run all the software that implement the control plane (routing protocols) and management plane (management interfaces such as CLI, NETCONF, gRPC, DHCP etc.) such as the system applications 208, the client applications 212, and the microservices 220 described below in more detail. The control card 108 typically has an off-the-shelf CPU (such as Intel or ARM) and runs some variant of an operating system (more recently, Linux or QNX or BSD), described below in more detail. Other embedded devices 100 include common cards that may also be added such as fan trays, power entry modules, and others that provide auxiliary functions of the chassis.

It should be noted that the diagram of the node 22 in FIG. 4 is simplified to include one controller card 108 in communication with multiple embedded devices 100. It is understood that the node 22 may include more than one controller card 108, and each controller card 108 may be in communication with one or more embedded device 100 via the same or a different communication device 104.

The number of devices illustrated in FIG. 4 is provided for explanatory purposes. In practice, there may be additional devices, fewer devices, different devices, or differently arranged devices than are shown in FIG. 4. Furthermore, two or more of the devices illustrated in FIG. 4 may be implemented within a single device, or a single device illustrated in FIG. 4 may be implemented as multiple, distributed devices. Additionally, one or more of the devices illustrated in FIG. 4 may perform one or more functions described as being performed by another one or more of the devices illustrated in FIG. 4. Devices illustrated in FIG. 4 may interconnect via wired connections (e.g., fiber-optic connections).

Referring now to FIG. 5, shown therein is an exemplary embodiment of the embedded device 100 constructed in accordance with the present disclosure. In some embodiments, the embedded device 100 may include, but is not limited to, one or more input device 120 (hereinafter “input device 120”), one or more output device 124 (hereinafter “output device 124”), one or more processor 128 (hereinafter “processor 128”), one or more communication device 132 (hereinafter “communication device 132”) operable to interface with the communication device 104, one or more non-transitory computer-readable medium 136 (hereinafter “memory 136”) storing processor-executable code and/or software application(s) (described below in more detail). The input device 120, output device 124, processor 128, communication device 132, and memory 136 may be connected via a path 144 such as a data bus that permits communication among the components of the embedded device 100.

The input device 120 may be capable of receiving client data and transmitting the client data to other components of the system 10. The input device 120 may include, but is not limited to, implementation as an optical network interface, an electrical network interface, combinations thereof, and/or the like, for example.

The output device 124 may be capable of outputting client data. For example, implementations of the output device 124 may include, but are not limited to, implementation as an optical network interface, an electrical network interface, combinations thereof, and/or the like, for example.

Referring now to FIG. 6, shown therein is an exemplary embodiment of the controller card 108 constructed in accordance with the present disclosure. In some embodiments, the controller card 108 may include, but is not limited to, one or more input device 150 (hereinafter “input device 150”), one or more output device 154 (hereinafter “output device 154”), one or more processor 158 (hereinafter “processor 158”), one or more communication device 162 (hereinafter “communication device 162”) operable to interface with the communication device 104, one or more non-transitory memory 166 (hereinafter “memory 166”) storing processor-executable code and/or software application(s) (described below in more detail). The input device 150, output device 154, processor 158, communication device 162, and memory 166 may be connected via a path 170 such as a data bus that permits communication among the components of the controller card 108.

The input device 150 may be capable of receiving client data and transmitting the client data to other components of the system 10. The input device 150 may include, but is not limited to, implementation as an optical network interface, an electrical network interface, combinations thereof, and/or the like, for example.

The output device 154 may be capable of outputting client data. For example, implementations of the output device 154 may include, but are not limited to, implementation as an optical network interface, an electrical network interface, combinations thereof, and/or the like, for example.

Referring now to FIG. 7, shown therein is a functional diagram of the network element 22 constructed in accordance with the present disclosure. The network element 22 generally includes a chassis 101 having a controller card 108 (FIG. 6) and at least one pluggable card 102. The pluggable card 102 may include the embedded device 100a and the embedded device 100b, as shown. As used herein, a processor block may refer to a combination of components of a device including a memory, a processor, and a communication device. Thus, also shown is a processor block 200a of the embedded device 100a comprising a processor 128a, a memory 136a, and a communication device 132a; a processor block 200b of the embedded device 100b comprising a processor 128b, a memory 136b, and a communication device 132b; and a processor block 200c of the controller card 108 comprising the processor 158, the memory 166, and the communication device 162.

As shown in FIG. 7, each processor block 200 includes computer software stored on a memory. The computer software may include a common software stack 204 having one or more system application 208a-n and one or more client application 212a-n, and a microservice stack 216 comprising one or more microservice 220a-n. In one embodiment, the microservice stack 216, the one or more client application 212, and, optionally, one or more system application 208 may be containerized applications and/or services that can communicate with each other via a virtualized network 224. An exemplary container framework may include Docker, and the virtualized network 224 may be a docker network, for example.

In one embodiment, the one or more system applications 208 includes one or more of a Linux distribution 208a, a boot configuration 208b (such as Uboot, a File System), a networking configuration 208c, an interface block 208d, and system services 208e (such as security services, watchdog, FDR, Host Daemons, virtualization infrastructure, systlog-ng, upgrade services, and a device microservice), for example. Each implementation of the common software stack 204 may include the same computer software having the same version on each processor block 200 having the common software stack 204.

The Linux distribution 208a may include, for example, Debian, Ubuntu, Arch, Fedora, and/or the like. The boot configuration 208b may ensure that the Filesystem design is replicated for each common software stack 204 and that a common boot procedure, such as Uboot, is implemented in each common software stack 204.

The networking configuration 208c may ensure replication of networking setup between processor blocks 200 such that pluggable cards 102 use DHCP to acquire an IP address, e.g., from the communication device 104 and/or from the controller card 108.

The interface block 208d may provide a secure entry-point to the common software stack 204 and/or other software stored on the memory, e.g., the memory 166, 136a, 136b. The interface block 208d may be defined using protocol buffers, e.g., protobuf. The interface block 208d may implement gnmi compliant APIs, such as GET, SET, SUBSCRIBE, and CAPABILITIES). In some embodiments, the interface block 208d is a data-driven interface and is scalable. In some embodiments, the interface block 208d maintains backwards compatibility with prior versions. In this way, security is maintained as the messaging server 212a (below) is the entry point into systems in the processor block 200 and API validation and security are ensured through the messaging server 212a.

In one embodiment, system services 208e (such as security services, watchdog, FDR, Host Daemons, virtualization infrastructure, systlog-ng, and upgrade services) may be managed using a system service control application, such as ‘systemctl’.

In one embodiment, the one or more client application 212 includes one or more of the messaging server 212a and a database 212b, for example. In some embodiments, the messaging server 212a is a REDIS server. In some embodiments, the database 212b is a relational database or a non-relational database and is preferably a time-series database. Exemplary databases implemented as the database 212b may include DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, and/or the like. It should be understood that these examples have been provided for the purposes of illustration only and should not be construed as limiting the presently disclosed inventive concepts.

In one embodiment, other client applications 212 include a messaging server adapter 212c, e.g., a grpc-adapter, and a database adapter 212d, e.g., redis-adapter. Each client application 212, for example, the messaging server 212a, the database 212b, the messaging server adapter 212c, and the database adapter 212d, may be common across all processor blocks 200. The configuration of each of the messaging server 212a, the database 212b, the messaging server adapter 212c, and the database adapter 212d may be tailored to a particular subsystem requirement through a change to a configuration file.

Additionally, when each of the messaging server 212a, the database 212b, the messaging server adapter 212c, and the database adapter 212d are implemented as containers in the processor block, container orchestration may be configured using a container configuration file, e.g., a ‘docker-compose.yml’ file when Docker is used for container implementation.

In one embodiment, the microservices 220 are processor block specific microservices, i.e., the microservices 220 stored in a memory of a particular processor block 200 are determined by each device 228 that may be in communication with the particular processor block 200, as described below. Exemplary microservices 220 include: a board initialization microservice, a Hal Platform control plane microservice, a data plane microservice, a TOM Microservice, and a board microservice.

The board initialization microservice may, for example, bring up one or more interface on a board, e.g., the controller board 108 and/or the pluggable card 102, and program a first state after power up or reboot of the board. The Hal Platform control plane microservice may determine a routing of data and manage network specific interfaces. The data plane microservice may manage and control data handling, processing, and forwarding. The TOM microservice may include optical module control such as control of one or more component on an optical plane such as an optical transceiver, for example. The board microservice may monitor one or more component of the board, e.g., the controller board 108, the node 22, and/or the pluggable card 102, for faults, performance, and board status related actions.

In one embodiment, a third-party agent software 232 is shown executing in a third-party device 236. The third-party device 236 may be one or more of the cloud-based server 30 and/or the user device 18, for example.

As shown in FIG. 7, the network element 22 generally includes one or more device 228a-n, depicted as devices 228a-g. Each processor block 200 in communication with a particular device 228 may include at least one microservice 220 to manage the particular device 228. For example, the processor block 200a in communication with the device 228c and the device 228d includes a microservice 220c and a microservice 220d to manage the device 228c and the device 228d, respectively; the processor block 200b in communication with the device 228e includes a microservice 220e to manage the device 228e; and the processor block 200c in communication with the device 228a and the device 228b includes a microservice 220a and a microservice 220b to manage the device 228a and the device 228b, respectively. Each microservice 220 may be unique for each processor block 200.

Exemplary devices 228 may include, for example, customized silicon such as ASICs or FPGAs, a router line-card, a DSP module, an optical/photonic circuit, an optical transceiver, a WSS, a VOA, a EDFA, Layer 0 elements described above, Layer 1 elements described above, and other components necessary for functioning of the network element 22, and the like. For example, as shown in FIG. 7, the device 228c may be a first FPGA, the device 228d may be an ASIC, the device 228e may be a second FPGA in communication with the device 228d, the device 228f may be a DSP in communication with the device 228c, and the device 228g may be an optical transceiver in communication with the device 228d.

In one embodiment, each processor block 200 further includes a microservice 220 for a device 228 that is connected indirectly to the processor block 200. While not shown in FIG. 7 for simplicity, the processor block 200a may, in some embodiments, further include a microservice 220f, a microservice 220g, and a microservice 220e to manage a device 228f, a device 228g, and the device 228e, respectively, as the device 228f is indirectly connected to the processor block 200a through the device 228c and the devices 228g, 228e are indirectly connected to the processor block 200a through the device 228d. Likewise, the processor block 200b may, in this embodiment, further include the microservice 220d and the microservice 220g to manage the devices 228d, 228g respectively as the device 228g is indirectly connected to the processor block 200b through the device 228d, which is further indirectly connected to the processor block 200b through the device 228e, for example.

In some embodiments, the controller card 108 may include one or more microservice 220, for example, microservice 220h, to provide communication between the controller card 108 and one or more processor block 200 of the pluggable card 102, such as via the communication device 132b of the processor block 200b as shown in FIG. 7. In some embodiments, when the processor block 200c communicates with the processor block 200b via the microservice 220h, microservices 220 on the virtualized network 224 in the processor block 200c may communicate with one or more microservice 220 on the virtualized network 224 in the processor block 200b. Here, the virtualized network 224 in the processor block 200c and the virtualized network 224 in the processor block 200b may be the same virtualized network 224.

In one embodiment, one or more of the microservices 220 may communicate with more than one device 228. In another embodiment, a first microservice 220 may act as an intermediary between two or more devices 228. In yet another embodiment, a first microservice 220 may act as an intermediary between a first device 228 and a second microservice 220.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A network element, comprising:
a controller card, comprising:
a first processor;
a first memory, the first memory being a first non-transitory computer-readable medium storing computer-executable instructions comprising a common software stack and a first microservice stack; and
a first device;
wherein the first microservice stack includes a first microservice operable to manage the first device; and
a pluggable card, comprising:
a second processor;
a second memory, the second memory being a second non-transitory computer-readable medium storing computer-executable instructions comprising the common software stack and a second microservice stack; and
a second device;
wherein the second microservice stack includes a second microservice operable to manage the second device.

2. The network element of claim 1, wherein the controller card further comprises a first communication device and the pluggable card further comprises a second communication device, and wherein the controller card communicates with the pluggable card via the first communication device in communication with the second communication device.

3. The network element of claim 2, wherein the first microservice stack of the first memory of the controller card further includes a third microservice operable to manage the communication between the first communication device and the second communication device.

4. The network element of claim 1, wherein the first microservice stack is containerized.

5. The network element of claim 1, wherein the first processor is one or more of an FPGA, ASIC, microprocessor, ARM processor, x86 processor, and a DSP.

6. The network element of claim 1, wherein the first device and the second device are one or more of an ASIC, an FPGA, a router line-card, a DSP, an optical transceiver, a WSS, a VOA, and an EDFA.

7. The network element of claim 1, wherein the controller card and the pluggable card communicate using a TCP/IP protocol.

8. The network element of claim 1, wherein the first microservice stack and the second microservice stack are containerized.

9. The network element of claim 8, wherein the containerized first microservice stack is in communication with the containerized second microservice stack via a virtualized network.

10. The network element of claim 1, wherein the first memory of the controller card further stores computer-executable instructions including a client application stack, wherein the client application is separate from the microservice stack and the common software stack wherein the client application stack includes a messaging service and a database.

11. The network element of claim 10, wherein the database is a time-series database.

12. The network element of claim 11, wherein the time-series database is a REDIS database.

13. The network element of claim 10, wherein the messaging service utilizes a remote procedure call.

14. The network element of claim 13, wherein the remote procedure call is a gRPC.

15. The network element of claim 10, wherein the messaging service is containerized and the database is containerized.

16. The network element of claim 1, wherein the common software stack includes an interface service defined using protocol buffers.

17. The network element of claim 16, wherein the interface service exposes one or more gnmi-compliant API.

18. The network element of claim 16, wherein the first memory of the controller card further stores computer-executable instructions including a client application stack,
wherein the client application is separate from the microservice stack and the common software stack, the client application stack including a messaging service and a database; and
wherein communications received by the interface service are routed by the messaging service.

19. The network element of claim 18, wherein communications received by the interface service are verified by the messaging service.

20. The network element of claim 19, wherein the interface service exposes one or more gnmi-compliant API, and wherein the messaging service is further operable to validate messaged received through the gnmi-compliant API.
